(19) United States
(12) Patent Application Publication
(10) Pub. No.: US 2012/0095968 A1
(43) Pub. Date: Apr. 19, 2012

(54) STORAGE TIERS FOR DIFFERENT BACKUP TYPES

(76) Inventor: Stephen Gold, Fort Collins, CO (US)

(21) Appl. No.: 12/906,108

(22) Filed: Oct. 17, 2010

(51) Int. Cl. G06F 12/16; G06F 17/30

(52) U.S. Cl. 707/652; 707/E17.005

(57) ABSTRACT

Systems and methods of providing storage tiers for different backup types. An embodiment of a method includes receiving a backup job from a client for data on a virtualized storage node. The method also includes identifying a type of the backup job. The method also includes storing data on at least one other virtualized storage node in a first tier or a second tier. Selection between the first tier and the second tier is based on the type of the backup job.

### BACKGROUND

Storage devices commonly implement data backup operations using virtual storage products for data recovery. Some virtual storage products have multiple backend storage devices that are virtualized so that the storage appears to a client as discrete storage devices, while the backup operations may actually be storing data across a number of the physical storage devices.

During operation, the user may desire to save some backup jobs on one node, and then migrate the backup jobs to other nodes for longer term storage. A time based migration policy does not efficiently handle the common case where users have different retention schemes. For example, retention schemes may specify weekly full backups (with daily incremental backups) for file servers, and daily full backups for database servers. Retaining a full week of data results in multiple full backups being stored for the databases and consumes a lot of disk space.

To avoid consuming large volumes of disk space, the user may partition the backup device into different targets (e.g., different virtual libraries), such that different backup retention times are grouped together. For example, all weekly full backups go to one target, and the daily full backups go to another target. The user then has different retention times for each target. For example, daily retention for the daily full target, and weekly retention for the weekly full target. Unfortunately, this policy increases the user administration load because now the user cannot just simply direct all backups to a single backup target, and instead has to manually direct each backup job to the appropriate target.

Forcing the user to choose between consuming a lot of disk space and performing more administrative tasks is counter to the value proposition of an enterprise backup device where the goal is to save disk space and reduce or altogether eliminate user administration tasks.

### BRIEF DESCRIPTION OF THE DRAWINGS

FIG. 1 is a high-level diagram showing an example of a storage system including a plurality of virtualized storage nodes which may be utilized to provide storage tiers for different backup types.

FIG. 2 illustrates an example of software architecture which may be implemented in the storage system to provide storage tiers for different backup types.

FIG. 3 is a flow diagram illustrating operations which may be implemented to provide storage tiers for different backup types.

### DETAILED DESCRIPTION

Systems and methods are disclosed to provide storage tiers for different backup types in virtualized storage nodes, for example, during backup and restore operations for an enterprise. It is noted that the term “backup” is used herein to refer to backup operations including echo-copy and other proprietary and non-proprietary data operations now known or later developed. Briefly, a storage system is disclosed including a plurality of physical storage nodes. The physical storage nodes are virtualized as one or more virtual storage devices (e.g., a virtual storage library having virtual data cartridges that can be accessed by virtual storage drives). Data may be backed-up to a virtual storage device presented to the client as having discrete storage devices (e.g., data cartridges). However, the data for a discrete storage device may actually be stored on any one or more of the physical storage devices.

An enterprise backup device may be provided with two or more tiers of storage within the same device. For example, a first tier (e.g., a faster tier) may be used for non-deduplicating storage for faster restore times. A second tier (e.g., a slower tier) may be used for deduplication storage to reduce storage consumption. If a user desires guaranteed backup performance and full restore performance for the most recent backups, the most recent backups should be stored on the first tier, and then the backup data is internally migrated or replicated from the first tier to the second tier based on a migration or replication policy.

In order to manage data on the different tiers, the policy cannot be simply time based, because time based policies do not necessarily always store “recent” backups in the fast tier. That is, if some servers run full backups every day, and some servers run full backups every week, and the policy migrates backups older than one day to the second tier, then the weekly full backup will be removed from the fast tier. Alternatively, if the policy migrates backups older than one week to the second tier, then a week of daily full backups are retained in the fast tier, thus consuming unnecessary disk space on the first tier. Therefore, the policy is based at least in part on the type of backup job.

The systems and methods described herein enable the backup device to identify the type of backup jobs (e.g., full or incremental). For example, incoming backup streams may be decoded to read backup type information in meta-data embedded in the backup streams. In another example, such as with the open storage (OST) backup protocol, the backup type may be determined from image metadata directly when an image is created on the backup device. In any event, migration policies may be established based on backup type instead of, or in addition to, time-based parameters.

In an embodiment, a system for satisfying service level objectives for different backup types includes an interface between a plurality of virtualized storage nodes and a client. The interface is configured to identify a type of a backup job from the client for backing up data on a virtualized storage node. In an example, the type of the backup job is one of full and incremental. A migration manager is operatively associated with the interface, the migration manager is configured to manage migrating data on at least one other virtualized storage node in a first tier or a second tier. The migration manager is configured to select between the first tier (e.g., a faster tier for non-deduplicated data) and the second tier (e.g., a slower tier for deduplicated data) based at least on the type of the backup job (e.g., full or incremental).

The systems and methods described herein enable a user to intelligently control what backup data is retained on a faster tier and what data can be moved to a slower tier. The most recent backup jobs can be quickly restored and older backup jobs can be deduplicated to reduce disk space usage. Accordingly, users do not need to partition the storage device into multiple smaller targets for each retention scheme, or consume unnecessary disk space in the faster tier due to varying retention schemes.

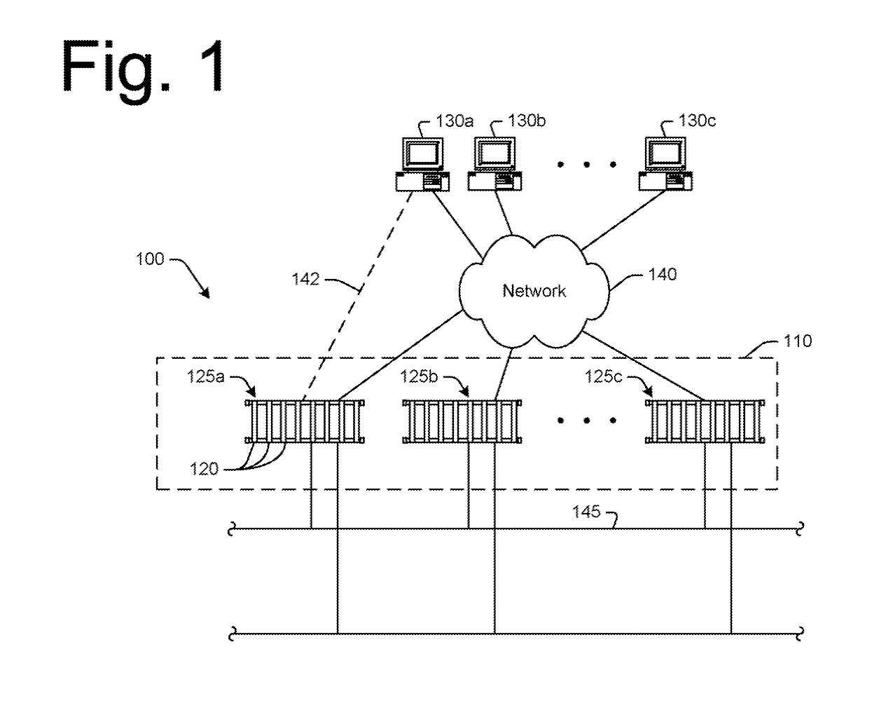

FIG. 1 is a high-level diagram showing an example of a storage system 100 which may be utilized to provide storage tiers for different backup types. Storage system 100 may include a storage device 110 with one or more storage nodes 120. The storage nodes 120, although discrete (i.e., physically distinct from one another), may be logically grouped into one or more virtual devices 125a-c (e.g., a virtual library including one or more virtual cartridges accessible via one or more virtual drive).

For purposes of illustration, each virtual cartridge may be held in a “storage pool,” where the storage pool may be a collection of disk array LUNs. There can be one or multiple storage pools in a single storage product, and the virtual cartridges in those storage pools can be loaded into any virtual drive. A storage pool may also be shared across multiple storage systems.

The virtual devices 125a-c may be accessed by one or more client computing device 130a-c (also referred to as “clients”), e.g., in an enterprise. In an embodiment, the clients 130a-c may be connected to storage system 100 via a “front-end” communications network 140 and/or direct connection (illustrated by dashed line 142). The communications network 140 may include one or more local area network (LAN) and/or wide area network (WAN) and/or storage area network (SAN). The storage system 100 may present virtual devices 125a-c to clients via a user application (e.g., in a “backup” application).

The terms “client computing device” and “client” as used herein refer to a computing device through which one or more users may access the storage system 100. The computing devices may include any of a wide variety of computing systems, such as stand-alone personal desktop or laptop computers (PC), workstations, personal digital assistants (PDAs), mobile devices, server computers, or appliances, to name only a few examples. Each of the computing devices may include memory, storage, and a degree of data processing capability at least sufficient to manage a connection to the storage system 100 via network 140 and/or direct connection 142.

In an embodiment, the data is stored on more than one virtual device 125, e.g., to safeguard against the failure of any particular node(s) 120 in the storage system 100. Each virtual device 125 may include a logical grouping of storage nodes 120. Although the storage nodes 120 may reside at different physical locations within the storage system 100 (e.g., on one or more storage device), each virtual device 125 appears to the client(s) 130a-c as individual storage devices. When a client 130a-c accesses the virtual device 125 (e.g., for a read/write operation), an interface coordinates transactions between the client 130a-c and the storage nodes 120.

The storage nodes 120 may be communicatively coupled to one another via a “back-end” network 145, such as an inter-device LAN. The storage nodes 120 may be physically located in close proximity to one another. Alternatively, at least a portion of the storage nodes 120 may be “off-site” or physically remote from the local storage device 110, e.g., to provide a degree of data protection.

The storage system 100 may be utilized with any of a wide variety of redundancy and recovery schemes for migrating data stored from the clients 130. Although not required, in an embodiment, deduplication may be implemented for migrating. Deduplication has become popular because as data growth soars, the cost of storing data also increases, especially backup data on disk. Deduplication reduces the cost of storing multiple backups on disk. Because virtual tape libraries are disk-based backup devices with a virtual file system and the backup process itself tends to have a great deal of repetitive data, virtual cartridge libraries lend themselves particularly well to data deduplication. In storage technology, deduplication generally refers to the reduction of redundant data. In the deduplication process, duplicate data is deleted, leaving only one copy of the data to be stored. Accordingly, deduplication may be used to reduce the required storage capacity because only unique data is stored. That is, where a data file is conventionally backed up X number of times, X instances of the data file are saved, multiplying the total storage space required by X times. In deduplication, however, the data file is only stored once, and each subsequent time the data file is simply referenced back to the originally saved copy.

With a virtual cartridge device that provides storage for deduplication, the net effect is that, over time, a given amount of disk storage capacity can hold more data than is actually sent to it. For purposes of example, a system containing 1 TB of backup data which equates to 500 GB of storage with 2:1 data compression for the first normal full backup. If 10% of the files change between backups, then a normal incremental backup would send about 10% of the size of the full backup or about 100 GB to the backup device. However, only 10% of the data actually changed in those files which equates to a 1% change in the data at a block or byte level. This means only 10 GB of block level changes or 5 GB of data stored with deduplication and 2:1 compression. Over time, the effect multiplies. When the next full backup is stored, it will not be 500 GB, the deduplicated equivalent is only 25 GB because the only block-level data changes over the week have been five times 5 GB incremental backups. A deduplication-enabled backup system provides the ability to restore from further back in time without having to go to physical tape for the data.

With multiple nodes (with non-shared back-end storage) each node has its own local storage. A virtual library spanning multiple nodes means that each node contains a subset of the virtual cartridges in that library (for example each node's local file system segment contains a subset of the files in the global file system). Each file represents a virtual cartridge stored in a local file system segment which is integrated with a deduplication store. Pieces of the virtual cartridge are contained in different deduplication stores based on references to other duplicate data in other virtual cartridges.

The deduplicated data, while reducing disk storage space, can take longer to complete a restore operation. It is not so much that a deduplicated cartridge may be stored across multiple physical nodes/arrays, but rather the restore operation is slower because deduplication means that common data is shared between multiple separate virtual cartridges. So when restoring any one virtual cartridge, the data will not be stored in one large sequential section of storage, but instead will be spread around in small pieces (because whenever a new backup is written, the common data within that backup becomes a reference to a previous backup, and following these references during a restore means going to the different storage locations for each piece of common data). Having to move from one storage location to another random location is slower because it requires the disk drives to seek to the different locations rather than reading large sequential sections. Therefore, it is desirable to maintain the most recent backup job in a first tier (e.g., a faster, non-deduplicating tier), while migrating older backup jobs to a second tier (e.g., a slower, deduplicating tier).

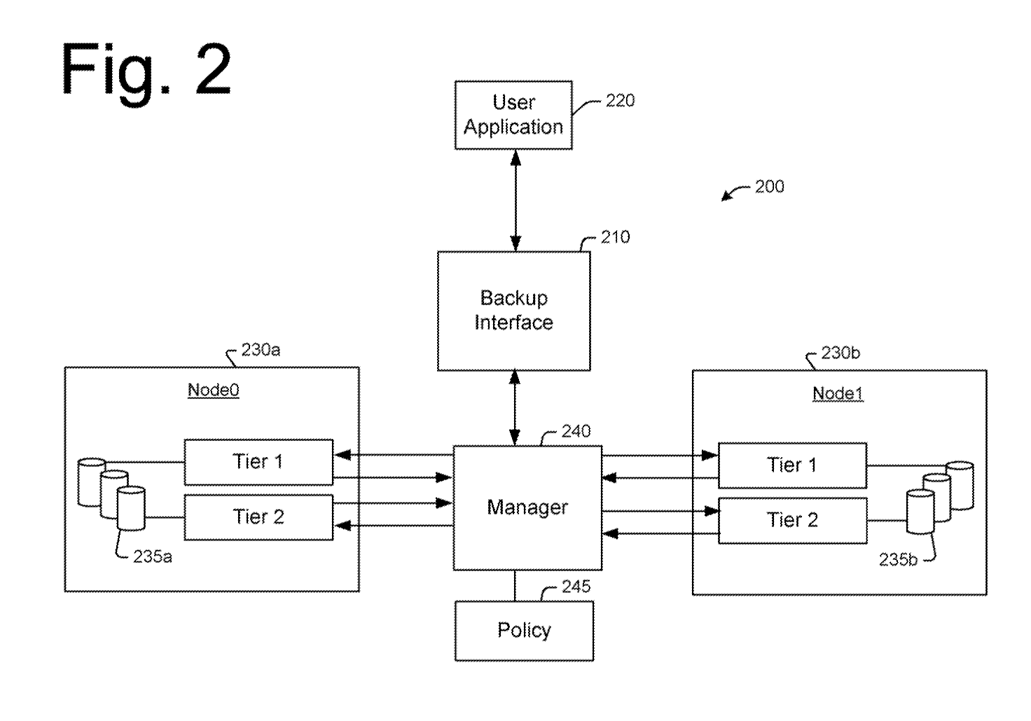

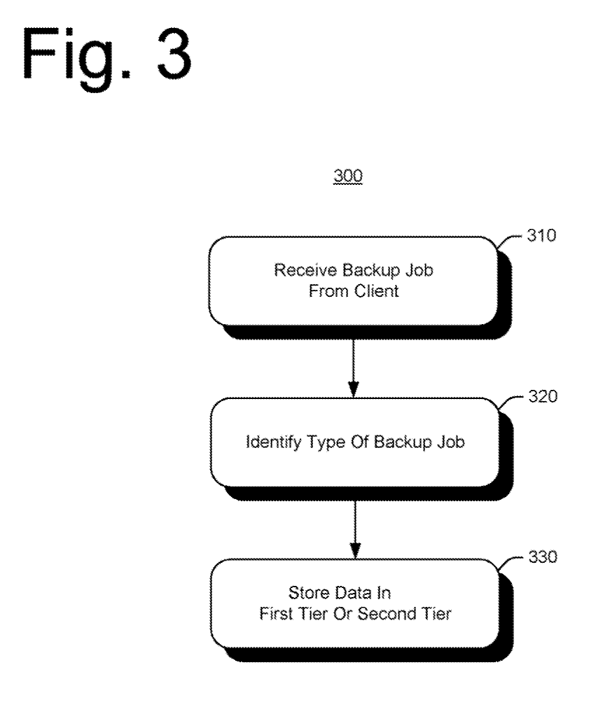

The systems and methods described herein enable the backup device to determine the type of backup jobs (e.g., full or incremental), so that migrating policies may be established based on backup type instead of time-based parameters. Such systems and methods for satisfying service level objectives for different backup types in virtualized storage nodes may be better understood by the following discussion and with reference to FIGS. 2 and 3.

FIG. 2 shows an example of software architecture 200 which may be implemented in the storage system (e.g., storage system 100 shown in FIG. 1) to provide storage tiers (e.g., Tier 1 and Tier 2) for different backup types. It is noted that the components shown in FIG. 2 are provided only for purposes of illustration and are not intended to be limiting. For example, although only two virtualized storage nodes (Node0 and Node1) and only two tiers (Tier 1 and Tier 2) are shown in FIG. 2 for purposes of illustration, there is no practical limit on the number of virtualized storage nodes and/or storage tiers which may be utilized.

It is also noted that the components shown and described with respect to FIG. 2 may be implemented in program code (e.g., firmware and/or software and/or other logic instructions) stored on one or more computer readable medium and executable by a processor to perform the operations described below. The components are merely examples of various functionality that may be provided, and are not intended to be limiting.

In an embodiment, the software architecture 200 may comprise a backup interface 210 operatively associated with a user application 220 (such as a backup application) executing on or in association with the client. The backup interface 210 may be provided on the storage device itself, and is configured to identify a type of a backup job being received at the storage device from the client (e.g., via user application 220) for backing up data on one or more virtualized storage node 230a-b each including storage 235a-b, respectively. A data or tier manager 240 for storing and/or migrating data is operatively associated with the backup interface 210.

The manager 240 is configured to manage migrating of data on at least one other virtualized storage node (e.g., node 230a) in a first tier or a second tier (or additional tiers, if present). The migration manager is configured to select between the first tier and the second tier based on the type of the backup job.

In an example, the manager 240 applies a policy 245 that maintains the most recent backup job in the first tier, and migrates prior backup jobs in the second tier, for example on at least one other virtualized storage node (e.g., node 230b). The manager 240 may also include, or be operatively associated with a conversion manager configured to convert a prior backup job in the first tier to a format for migrating in the second tier. Also in an example, the first tier is for non-deduplicated data and the second tier is for deduplicated data. The first tier provides faster restore to the client of the backup job than the second tier, and the second tier provides greater storage capacity than the first tier.

For purposes of illustration, in a simple non-deduplication example, the entire contents of a virtual cartridge may be considered to be a single file held physically in a single node file system segment, and accordingly restore operations are much faster than in a deduplication example. In a deduplication example, each backup job (or portion of a backup job) stored on the virtual tape may be held in a different deduplication store, with each store in a different node. In this example, in order to access data for the restore operation, since different sections of the virtual cartridge may be in different deduplication stores, the virtual drive may need to move to different nodes as the restore operation progresses through the virtual cartridge, and therefore is slower.

While non-deduplication is faster, deduplication consumes less storage space. Thus, the user may desire to establish backup policies which utilize both deduplication and non-deduplication.

During operation, the backup interface 210 determines the type of the backup jobs (e.g., full or incremental) so that migration policy 245 may be established in terms of type of backup job (e.g., “how many full backup and subsequent non-full backups are to be retained”) instead of, or in addition to, being time based. If the user establishes a policy to “retain 1 full backup and subsequent non-full backups,” then with a weekly full backup the most recent full backup and up to one week of daily incremental backups are retained on the fast tier. When the second full backup is run, the previous full backup is migrated to the second tier. With daily full backups, in one example, this policy would retain the most recent full backup while, migrating the previous day's full backup on another node.

The backup device is configured with some basic awareness of the backup jobs being stored, in terms of backup job name and job type (e.g., full and incremental).

One example for providing this awareness is with the OST backup protocol, where the backup job name and type are encoded in the meta-data provided by the OST interface whenever a new backup image is created on the device. Thus, whenever an OST image is created (with a backup job name and type) on the backup device, this serves as a trigger for analyzing existing backups on the first (faster) tier, and based on the migration policy, start migration the previous version of that backup to another node. In another example, using a virtual tape model, the device may “inline decode” the incoming backup streams to locate the name/type information in the backup application meta-data embedded in the backup stream.

Accordingly, when a new full backup is successfully stored on the device and correlated with the previous full version, this backup can then be migrating to another node. The migration manager then manages migrating data to the other virtualized storage node on the second (slower) tier, e.g., implementing deduplication.

Before continuing, it is noted that although implemented as program code, the components described above with respect to FIG. 2 may be operatively associated with various hardware components for establishing and maintaining a communications links, and for communicating the data between the storage device and the client.

It is also noted that the software link between components may also be integrated with replication and deduplication technologies. In use, the user can setup replication and run replication jobs in a user application (e.g., the “backup” application) to replicate data in a virtual cartridge. While the term “backup” application is used herein, any application that supports replication operations may be implemented.

Although not limited to any particular usage environment, the ability to better schedule and manage backup “jobs” is particularly desirable in a service environment where a single virtual storage product may be shared by multiple users (e.g., different business entities), and each user can determine whether to add a backup job to the user's own virtual cartridge library within the virtual storage product.

In addition, any of a wide variety of storage products may also benefit from the teachings described herein, e.g., files sharing in network-attached storage (NAS) or other backup devices. In addition, the remote virtual library (or more generally, “target”) may be physically remote (e.g., in another room, another building, offsite, etc.) or simply “remote” relative to the local virtual library.

Variations to the specific implementations described herein may be based on any of a variety of different factors, such as, but not limited to, storage limitations, corporate policies, or as otherwise determined by the user or recommended by a manufacturer or service provider.

FIG. 3 is a flow diagram 300 illustrating operations which may be implemented to provide storage tiers for different backup types. Operations described herein may be embodied as logic instructions on one or more computer-readable medium. When executed by one or more processor, the logic instructions cause a general purpose computing device to be programmed as a special-purpose machine that implements the described operations.

In operation 310, a backup job is received from a client for data on a virtualized storage node. In operation 320, a type of the backup job is identified. In operation 330, data is stored on at least one other virtualized storage node in a first tier or a second tier based on the type of the backup job, selection between the first tier and the second tier based on the type of the backup job.

Other operations (not shown in FIG. 3) may also be implemented in other embodiments. For example, further operations may include maintaining a most recent backup job in the first tier, and migrating prior backup jobs on the at least one other virtualized storage node in the second tier. Operations may also include converting a prior backup job maintained in the first tier to a format for migrating to the second tier. Operations may also include limiting full backup jobs to one backup job in the first tier, wherein additional backup jobs are on the second tier.

In other examples, the first tier is for non-deduplicated data and the second tier is for deduplicated data. The first tier provides faster restore to the client of the backup job than the second tier. The second tier provides greater storage capacity than the first tier. The type of the backup job is one of full and incremental.

Accordingly, the operations enable a user to intelligently control what backup data is retained on the fast tier, such that they can meet their restore service level objectives, without having to consume disk space in the fast tier for all of the backup jobs.

It is noted that the embodiments shown and described are provided for purposes of illustration and are not intended to be limiting. Still other embodiments are also contemplated for satisfying service level objectives for different backup types.

1. A method of providing storage tiers for different backup types, comprising:
receiving a backup job from a client for data on a virtualized storage node;
identifying a type of the backup job; and
storing data on at least one other virtualized storage node in a first tier or a second tier, selection between the first tier and the second tier based on the type of the backup job.

2. The method of claim 1, further comprising maintaining recent backup jobs in the first tier based on a migration policy.

3. The method of claim 1, further comprising migrating prior backup jobs on the at least one other virtualized storage node in the second tier.

4. The method of claim 1, further comprising converting a prior backup job maintained in the first tier to a format for migrating to the second tier.

5. The method of claim 1, wherein the first tier is for non-deduplicated data and the second tier is for deduplicated data.

6. The method of claim 1, wherein the first tier provides faster restore to the client of the backup job than the second tier.

7. The method of claim 1, wherein the second tier provides greater storage capacity than the first tier.

8. The method of claim 1, wherein the type of the backup job is one of full and incremental.

9. The method of claim 1, further comprising limiting full backup jobs to one backup job in the first tier, wherein additional backup jobs are on the second tier.

10. A system providing storage tiers for different backup types for different backup types, comprising:
an interface between a plurality of virtualized storage nodes and a client, the interface configured to identify a type of a backup job from the client for backing up data on a virtualized storage node; and
a migration manager operatively associated with the interface, the migration manager configured to manage migrating of data on at least one other virtualized storage node in a first tier or a second tier, the migration manager configured to select between the first tier and the second tier based on the type of the backup job.

11. The system of claim 10, wherein at least one most recent backup job is maintained in the first tier based on a migration policy.

12. The system of claim 10, wherein prior backup jobs are migrating on the at least one other virtualized storage node in the second tier.

13. The system of claim 10, further comprising a conversion manager configured to convert a prior backup job in the first tier to a format for migrating to the second tier.

14. The system of claim 10, wherein the first tier is for non-deduplicated data and the second tier is for deduplicated data.

15. The system of claim 10, wherein the first tier provides faster restore to the client of the backup job than the second tier, and the second tier provides greater storage capacity than the first tier.

16. The system of claim 10, wherein the type of the backup job is one of full and incremental.

17. A backup system comprising program code stored on computer readable storage and executable by a processor to:
determine a type of a backup job from the client for backing up data on a virtualized storage node;
select between a first tier and a second tier virtualized storage node based on the type of the backup job; and
manage migrating of data in the selected first tier or second tier to satisfy service level objectives for different backup types.

18. The system of claim 17, wherein at least one backup job is maintained in the first tier, and prior backup jobs are moved to the second tier, based on a migration policy.

19. The system of claim 17, wherein the first tier is for non-deduplicated data and the second tier is for deduplicated data.

20. The system of claim 17, wherein the first tier provides faster restore to the client of the backup job than the second tier, and the second tier provides greater storage capacity than the first tier.
